(19) United States
(12) Patent Application Publication
(10) Pub. No.: US 2026/0175203 A1
(43) Pub. Date: Jun. 25, 2026

(54) CATALYST AND METHOD FOR MANUFACTURING THE SAME, AND METHOD FOR MANUFACTURING UNSATURATED NITRILE OR ALKENE

(71) Applicant: ASAHI KASEI KABUSHIKI KAISHA, Tokyo (JP)

(72) Inventors: Natsume KOIKE, Tokyo (JP); Yu ONODERA, Tokyo (JP)

(73) Assignee: ASAHI KASEI KABUSHIKI KAISHA, Tokyo (JP)

(21) Appl. No.: 19/242,713

(22) Filed: Jun. 18, 2025

Related U.S. Application Data
(63) Continuation-in-part of application No. PCT/JP2023/044821, filed on Dec. 14, 2023.

(30) Foreign Application Priority Data
Dec. 19, 2022 (JP) 2022-202504

(51) Int. Cl. B01J 23/888; B01J 23/887; B01J 29/08

(52) U.S. Cl. CPC B01J 23/8885; B01J 23/8876; B01J 29/084; B01J 2523/41; B01J 2523/55; B01J 2523/69

(57) ABSTRACT

A catalyst including a metal oxide containing molybdenum and vanadium, wherein the catalyst includes a P1 crystal and a P2 crystal, and a ratio of a crystal lattice constant of the P2 crystal in the C-axis direction to a crystal lattice constant of the P1 crystal in the C-axis direction is 1.0030 to 1.0100.

### TECHNICAL FIELD

This application is a Continuation-in-Part of PCT International Application No. PCT/JP2023/044821, filed on Dec. 14, 2023, which claims priority under 35 U.S.C. § 119(a) to Patent Application No. 2022-202504, filed in Japan on Dec. 19, 2022, all of which are hereby expressly incorporated by reference into the present application.

The present invention relates to a catalyst (preferably a catalyst for use in a vapor phase catalytic ammoxidation reaction or a vapor phase catalytic oxidation reaction) and a method for manufacturing the same, and a method for manufacturing an unsaturated nitrile or an alkene.

### BACKGROUND ART

A composite metal oxide containing molybdenum and vanadium has been used as a catalyst for an ammoxidation reaction in which a hydrocarbon, ammonia, and oxygen are allowed to react with each other to manufacture a nitrile, and various types of catalysts have been reported.

For example, Patent Literature 1 discloses “an oxide catalyst used for a vapor phase catalytic ammoxidation reaction of propane or isobutane, wherein the catalyst contains a composite oxide, the composite oxide contains a catalytically active species that is isolated from the composite oxide using a hydrogen peroxide solution, and in STEM-EDX measurement, the catalytically active species has an average composition represented by the following compositional formula (1): Compositional formula:

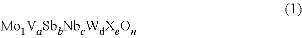

wherein X represents one or more selected from the group consisting of Te, Ce, Ti and Ta, a, b, c, and d satisfy relational expressions of 0.050≤a≤0.200, 0.050≤b≤0.200, 0.100≤c≤0.300, 0≤d≤0.100, 0≤e≤0.100, and a≤c, and n is a number determined by atomic valences of other elements”.

Patent Literature 2 discloses “a catalyst composition for ammoxidizing propane in a vapor phase, the catalyst composition being characterized in that the catalyst composition contains one or more crystal phases, at least one of the crystal phases is a first phase having a M1 crystal structure and containing a mixed metal oxide containing molybdenum (Mo), vanadium (V), antimony (Sb), and niobium (Nb), and the first phase has a unit lattice volume within the range of 2250A³ to 2350A³, a first crystal dimension, and a second dimension across this, with the proviso that the ratio of the first dimension to the second dimension is within the range of 2.5 to 0.7”.

Patent Literature 3 discloses “a method for manufacturing a mixed oxide material containing elements of molybdenum, vanadium, niobium, and tellurium, comprising
a) a step of manufacturing a mixture of starting compounds including molybdenum-, vanadium-, niobium-, and tellurium-containing starting compounds, the tellurium being in an oxidation state of +4,
b) a step of subjecting the mixture of the starting compounds to hydrothermal treatment at a temperature of 100° C. to 300° C. to obtain a product suspension,
c) a step of performing separation of a solid from the product suspension obtained from the step b) and drying thereof, and
d) a step of activating the solid in an inert gas to obtain a mixed oxide material,
wherein
   the tellurium-containing starting compound has a particle diameter D₉₀ of less than 100 μm”.

### CITATION LIST

### Patent Literature

Patent Literature 1: Japanese Patent No. 6827152
Patent Literature 2: Japanese Patent No. 5547057
Patent Literature 3: Japanese Translation of PCT International Application Publication No. 2020-514227

### SUMMARY OF INVENTION

### Technical Problem

Catalysts for manufacturing nitriles by ammoxidation reaction or catalysts for manufacturing alkenes by oxidation reaction have been variously reported, but there is still room for improvement. Accordingly, it is an object of the present invention to provide a catalyst suitable for manufacturing an unsaturated nitrile or an alkene and a method for manufacturing the same, and a method for manufacturing an unsaturated nitrile or an alkene using the catalyst.

### Solution to Problem

The present inventors have earnestly studied, and as a result, they have found that the yield of an unsaturated nitrile or an alkene is improved by controlling P1 crystals and/or P2 crystals contained in the catalyst, and have completed the present invention.

The present invention includes the following embodiments.

[1]

A catalyst comprising a metal oxide containing molybdenum and vanadium, wherein
the catalyst comprises a P1 crystal and a P2 crystal, and
a ratio of a crystal lattice constant of the P2 crystal in the C-axis direction to a crystal lattice constant of the P1 crystal in the C-axis direction is 1.0030 to 1.0100.
   [2]

The catalyst according to [1], wherein the crystal lattice constant of the P2 crystal in the C-axis direction is 4.0200 \acute{Å} to 4.0298 \acute{Å}.

[3]

The catalyst according to [1] or [2], wherein the crystal lattice constant of the P1 crystal in the C-axis direction is 3.9900 \acute{Å} to 4.0080 \acute{Å}.

[4]

The catalyst according to any one of [1] to [3], wherein the catalyst is for use in a vapor phase catalytic ammoxidation reaction or a vapor phase catalytic oxidation reaction.

[5]

The catalyst according to any one of [1] to [4], wherein an amount of the P2 crystal based on the total mass of the P1 crystal and the P2 crystal is 40 mass % or more.

[6]

The catalyst according to any one of [1] to [5], wherein the metal oxide is represented by the following formula (1):

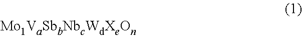

wherein X is at least one selected from the group consisting of Te, Ce, Ti, and Ta,
a is 0.01 or more and 1 or less,
b is 0.01 or more and 1 or less,
c is 0.01 or more and 1 or less,
d is 0 or more and 1 or less,
e is 0 or more and 1 or less, and
n is a value determined by the X and the a to e.
   [7]

A method for manufacturing a catalyst, comprising
a step of preparing a slurry containing molybdenum, vanadium, and a first wet silica,
a step of spray drying the slurry to obtain particles, and
a step of calcining the particles to obtain a catalyst, wherein
at least one of (1) and (2) below is satisfied:
(1) the method further comprises mixing a second wet silica with the slurry when pH of the slurry is 3 to 8; and
(2) in a solid-state ²⁹Si-NMR spectrum of the first wet silica, a ratio of the total area of Q2 signal and Q3 signal to the total area of Q2 signal, Q3 signal, and Q4 signal is 12 to 35%.
   [8]

The method according to [7], wherein the first wet silica and the second wet silica are silica sols.

[9]

The method according to [7] or [8], wherein the spray drying is performed within 60 minutes after the second wet silica is mixed.

[10]

A method for manufacturing an unsaturated nitrile, comprising a step of obtaining an unsaturated nitrile by a vapor phase catalytic ammoxidation reaction of a hydrocarbon in the presence of the catalyst according to any one of [1] to [6].

[11]

A method for manufacturing an alkene, comprising a step of obtaining an alkene by a vapor phase catalytic oxidation reaction of an alkane in the presence of the catalyst according to any one of [1] to [6].

### Advantageous Effect of Invention

According to the present invention, a catalyst suitable for manufacturing an unsaturated nitrile or an alkene and a method for manufacturing the same, and a method for manufacturing an unsaturated nitrile or an alkene using the catalyst can be provided.

### DESCRIPTION OF EMBODIMENTS

Hereinafter, embodiments of the present invention will be specifically described, but the present invention is not limited to these, and various modifications can be made without departing from the scope of the present invention.

### <Catalyst>

The catalyst according to the first embodiment of the present invention is a catalyst including a metal oxide containing molybdenum and vanadium, wherein the catalyst includes a P1 crystal and a P2 crystal, and a ratio of a crystal lattice constant of the P2 crystal in the C-axis direction (hereinafter also referred to as “P2-C-axis lattice constant”) to a crystal lattice constant of the P1 crystal in the C-axis direction (hereinafter also referred to as “P1-C-axis lattice constant”) is 1.0030 to 1.0100.

The catalyst according to the second embodiment of the present invention is a catalyst including a metal oxide containing molybdenum and vanadium, wherein the catalyst includes a P1 crystal and a P2 crystal, and a crystal lattice constant of the P2 crystal in the C-axis direction is 4.0200 \acute{Δ} to 4.0298 \acute{Å}.

The catalyst according to the third embodiment of the present invention is a catalyst including a metal oxide containing molybdenum and vanadium, wherein the catalyst includes a P1 crystal and a P2 crystal, and a crystal lattice constant of the P1 crystal in the C-axis direction is 3.9900 \acute{Å} to 4.0080 \acute{Å}.

Hereinafter, the catalysts according to the first to the third embodiments will be appropriately expressed altogether as the catalyst according to the present embodiment.

The catalyst according to the present embodiment can be preferably used in a vapor phase catalytic ammoxidation reaction. In the present specification, the “vapor phase catalytic ammoxidation reaction” is a reaction in which a hydrocarbon, ammonia, and molecular oxygen are allowed to react with each other in a vapor phase to obtain an unsaturated nitrile.

By using the catalyst according to the present embodiment, an unsaturated nitrile can be manufactured in a high yield. As the reason for this, the following is assumed, but the present invention is in no way limited by this assumed reason.

That is to say, of the P1 crystal and the P2 crystal contained in the catalyst, the P2 crystal tends to activate a hydrocarbon that is a starting material to improve the yield of an unsaturated nitrile, while the P1 crystal tends to decompose a hydrocarbon and an unsaturated nitrile.

Vanadium takes part in such activation and decomposition, and therefore, if vanadium is present in a large amount in the P2 crystal, the yield of the unsaturated nitrile tends to improve, and if vanadium is present in a large amount in the P1 crystal, the yield of the unsaturated nitrile tends to decrease.

Here, vanadium has a smaller atomic radius than molybdenum, so that as the amount of vanadium contained in a crystal increases, the lattice constant of the crystal becomes smaller, and as the amount of vanadium contained in a crystal decreases, the lattice constant of the crystal becomes larger.

On that account, in the P2 crystal that tends to improve the yield of the unsaturated nitrile, it is preferable that the amount of vanadium should increase and the lattice constant of the crystal should be smaller, and in the P1 crystal that tends to decrease the yield of the unsaturated nitrile, it is preferable that the amount of vanadium should decrease and the lattice constant of the crystal should be larger. In the present specification, that the lattice constants of the P2 crystal and the P1 crystal are smaller and larger, respectively is not due to comparison between a P2 crystal and a P1 crystal contained in the same catalyst, but due to comparison between P2 crystals or between P1 crystals contained in different catalysts. Therefore, even if the lattice constant of the P2 crystal contained in the catalyst according to the present embodiment is larger than the lattice constant of the P1 crystal contained in the same catalyst, and if it is smaller than the lattice constant of the P2 crystal contained in a different catalyst, it can be said that the lattice constant of the P2 crystal is smaller.

In the catalyst according to the first embodiment, the ratio of the P2-C-axis lattice constant to the P1-C-axis lattice constant is 1.0030 to 1.0100, and this means that the lattice constant of the P2 crystal is small, and the lattice constant of the P1 crystal is large, so that the yield of the unsaturated nitrile is expected to improve.

In the catalyst according to the second embodiment, the P2-C-axis lattice constant is 4.0200 \acute{Å} to 4.0298 \acute{Å}, and this means that the lattice constant of the P2 crystal is small, so that the yield of the unsaturated nitrile is expected to improve.

In the catalyst according to the third embodiment, the P1-C-axis lattice constant is 3.9900 \acute{Å} to 4.0080 \acute{Å}, and this means that the lattice constant of the P1 crystal is large, so that decomposition of the hydrocarbon and the unsaturated nitrile tends to occur, and the yield of the unsaturated nitrile is expected to improve consequently.

The catalyst according to the present embodiment can be preferably used in a vapor phase catalytic oxidation reaction. In the present specification, the “vapor phase catalytic oxidation reaction” is a reaction in which an alkane and molecular oxygen are allowed to react with each other in a vapor phase to obtain an alkene.

The catalyst according to the present embodiment includes a P1 crystal and a P2 crystal.

In the present specification, the “P1 crystal” means a crystal having, in an X-ray diffraction pattern, peaks at 22.1±0.5°, 28.1±0.5°, 36.1±0.5°, and 45.2±0.5°.

In the present specification, the “P2 crystal” means a crystal having, in an X-ray diffraction pattern, peaks at 7.8±0.5°, 8.9±0.5°, 22.1±0.5°, 27.1±0.5°, 35.2±0.5°, and 45.2±0.5°.

The X-ray diffraction patterns of the P1 crystal and the P2 crystal can be obtained in accordance with the method described in Examples.

The P1-C-axis lattice constant and the P2-C-axis lattice constant can be determined by Rietveld analysis, and specifically, they can be determined in accordance with the method described in Examples.

In the catalyst according to the first embodiment, a ratio of the P2-C-axis lattice constant to the P1-C-axis lattice constant (namely, [P2-C-axis lattice constant]/[P1-C-axis lattice constant]) is 1.0030 to 1.0100. From the viewpoint of improvement in yield of an unsaturated nitrile or alkene, the ratio is preferably 1.0037 to 1.0079, more preferably 1.0037 to 1.0075, more preferably 1.0037 to 1.0072, even more preferably 1.0037 to 1.0060. The catalysts according to the second and the third embodiments may have this feature.

In the catalyst according to the second embodiment, the P2-C-axis lattice constant is 4.0200 \acute{Å} to 4.0298 \acute{Å}. From the viewpoint of improvement in yield of an unsaturated nitrile or alkene, the P2-C-axis lattice constant is preferably 4.0210 \acute{Å} to 4.0290 \acute{Å}, more preferably 4.0210 \acute{Å} to 4.0285 \acute{Å}, even more preferably 4.0210 Å to 4.0275 \acute{Å}. The catalysts according to the first and the third embodiments may have this feature.

In the catalyst according to the third embodiment, the P1-C-axis lattice constant is 3.9900 \acute{Å} to 4.0080 \acute{Å}. From the viewpoint of improvement in yield of an unsaturated nitrile or alkene, the P1-C-axis lattice constant is preferably 3.9975 \acute{Å} to 4.0061 \acute{Å}, more preferably 3.9980 \acute{Å} to 4.0053 \acute{Å}, even more preferably 3.9988 \acute{Å} to 4.0053 \acute{Å}. The catalysts according to the first and the second embodiments may have this feature.

From the viewpoint of improvement in yield of an unsaturated nitrile or alkene, the amount of the P2 crystal based on the total mass of the P1 crystal and the P2 crystal in the catalyst according to the present embodiment is preferably 40 mass % or more, more preferably 46 mass % or more and 100 mass % or less, even more preferably 59 mass % or more and 95 mass % or less, particularly preferably 70 mass % or more and 90 mass % or less. The amount of the P2 crystal can be determined by Rietveld analysis, and specifically, it can be determined in accordance with the method described in Examples.

The metal oxide contained in the catalyst according to the present embodiment contains, as metal components, molybdenum (Mo) and vanadium (V). The metal oxide may contain further metal components. Examples of the further metal components include antimony (Sb), niobium (Nb), tungsten (W), tellurium (Te), cerium (Ce), titanium (Ti), and tantalum (Ta). From the viewpoint of improvement in yield of an unsaturated nitrile or alkene, the metal oxide is preferably represented by the following formula (1).

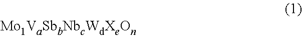

wherein X is at least one selected from the group consisting of Te, Ce, Ti, and Ta,
a is 0.01 or more and 1 or less, preferably 0.01 or more and 0.4 or less, more preferably 0.02 or more and 0.3 or less,
b is 0.01 or more and 1 or less, preferably 0.01 or more and 0.4 or less, more preferably 0.02 or more and 0.35 or less,
c is 0.01 or more and 1 or less, preferably 0.01 or more and 0.3 or less, more preferably 0.02 or more and 0.25 or less,
d is 0 or more and 1 or less, preferably 0 or more and 0.3 or less, more preferably 0 or more and 0.2 or less,
e is 0 or more and 1 or less, preferably 0 or more and 0.1 or less, more preferably 0 or more and 0.09 or less, and
n is a value determined by the X and the a to e (in other words, a value determined by atomic valences of other elements).

The composition of the metal oxide can be obtained in accordance with the method described in Examples.

The metal oxide contained in the catalyst according to the present embodiment may be supported on a carrier. The type of the carrier is not particularly limited, but it is preferably silica.

### <Method for Manufacturing Catalyst>

The method for manufacturing a catalyst according to the fourth embodiment of the present invention includes
a step of preparing a first slurry containing molybdenum, vanadium, and a first wet silica,
a step of mixing the first slurry with a second wet silica to prepare a second slurry when pH of the first slurry is 3 to 8,
a step of spray drying the second slurry to obtain particles, and
a step of calcining the particles to obtain a catalyst.

In the method according to the fourth embodiment, the P2 crystal can be preferentially manufactured, and the catalyst described in the aforementioned column <Catalyst> can be manufactured. As the reason for this, the following is assumed, but the present invention is in no way limited by this assumed reason.

That is to say, in the first slurry, various metal components and the first wet silica are in aggregated state, and by mixing this with the second wet silica, a slurry in which an aggregate and dispersed wet silica exist together can be obtained. By spray drying this, particles each having a silica layer formed on its surface are obtained. If a reducing gas (e.g., ammonia gas) is present when this particle is calcined, the reducing gas does not easily get inside the particle because of the presence of the silica layer on the surface. The P1 crystal is likely to be formed under the reduction conditions, but the silica layer inhibits penetration of the reducing gas inside the particle, so that formation of the P1 crystal is suppressed, and instead, the P2 crystal is likely to be formed. The reducing gas can be generated from, for example, a component used for the preparation of a slurry (e.g., ammonia) during calcining.

The first slurry may contain, in addition to molybdenum and vanadium, further metal components. Examples of the further metal components include those described in the aforementioned column <Catalyst>.

pH of the first slurry sometimes varies over time. When the first slurry is mixed with the second wet silica, pH of the first slurry is 3 to 8, preferably 4 to 8, more preferably 5 to 8, even more preferably 6 to 8. Since the pH of the first slurry is in the above range, the P2 crystal is likely to be formed.

The amount of the second wet silica is not particularly limited, but may be, for example, 3 to 70 mass %, 5 to 60 mass %, or 10 to 50 mass %, based on the mass of the total of silica used for manufacturing a catalyst.

The time from mixing of the second wet silica to spray drying is preferably 60 minutes or less, more preferably 40 minutes or less, even more preferably 30 minutes or less. As this time interval is shortened, the P2 crystal is more easily formed. The second wet silica means wet silica that is finally mixed with the slurry. Therefore, for example, when the wet silica is divided into 3 portions and they are mixed in sequence, the wet silica that is mixed for the third time is the second wet silica.

The wet silica is a classification of silica that makes a pair with dry silica, and means amorphous silicon dioxide synthesized in a liquid. A silica sol, precipitated silica, a silica gel, or the like corresponds thereto. The dry silica is silicon oxide manufactured by combustion of silicon tetrachloride, and the wet silica and the dry silica differ from each other in physiochemical properties.

The method for manufacturing a catalyst according to the fifth embodiment of the present invention includes
a step of preparing a slurry containing molybdenum, vanadium, and a wet silica,
a step of spray drying the slurry to obtain particles, and
a step of calcining the particles to obtain a catalyst, and
in a solid-state ²⁹Si-NMR spectrum of the wet silica, a ratio of the total area of Q2 signal and Q3 signal to the total area of Q2 signal, Q3 signal, and Q4 signal is 12 to 35%.

In the present specification, the “Q2 signal” is a signal derived from a (HO—)₂Si(—O—Si)₂ structure.

In the present specification, the “Q3 signal” is a signal derived from a HO—Si(—O—Si)₃ structure.

In the present specification, the “Q4 signal” is a signal derived from a Si(—O—Si)₄ structure.

The Q2 to Q4 signals can be obtained in accordance with the method described in Examples.

In the method according to the fifth embodiment, the P2 crystal can be preferentially manufactured, and the catalyst described in the aforementioned column <Catalyst> can be manufactured. As the reason for this, the following is assumed, but the present invention is in no way limited by this assumed reason.

That is to say, since the structures corresponding to the Q2 and Q3 signals tend to react with metal components due to the presence of a hydroxyl group, the metal components are dispersed and exist on the silica surface, and the metal components can be inhibited from being aggregated, so that the P2 crystal is preferentially formed.

A ratio of the total area of Q2 signal and Q3 signal to the total area of Q2 to Q4 signals is 12 to 35%, preferably 15 to 35%, more preferably 20 to 35%. This ratio can be adjusted by changing pH during preparation of silica or changing particle diameters of the silica particles. For example, by changing pH of the wet silica to be on the basic side, the ratio of the total area of Q2 and Q3 signals tends to increase. A method for changing pH to be on the basic side is a method of addition of a basic solution such as ammonia water, or the like. pH of the wet silica is preferably 12.4 or more, more preferably 12.5 or more. By decreasing the particle diameter of the silica particle, the ratio of the total area of Q2 and Q3 signals tends to increase. The particle diameter of the silica particle is preferably 19 nm or less, more preferably 16 nm or less. The particle diameter (primary particle diameter) of the silica particle can be determined by measuring a specific surface area by the nitrogen adsorption method and applying the following equation.

$$d = 6 / ( ρ \times s )$$

wherein d is an average particle diameter, s is a specific surface area, and p is a density of silica (2.2 g/cm³).

The slurry may contain, in addition to molybdenum and vanadium, further metal components. Examples of the further metal components include those described in the aforementioned column <Catalyst>.

The method according to the fourth embodiment and the method according to the fifth embodiment may be combined. That is to say, use of the second wet silica in the fourth embodiment and use of the wet silica having a prescribed structure in the fifth embodiment may be combined.

Specifically, it is a method for manufacturing a catalyst, including
a step of preparing a first slurry containing molybdenum, vanadium, and a first wet silica,
a step of mixing the first slurry with a second wet silica to prepare a second slurry when pH of the first slurry is 3 to 8,
a step of spray drying the second slurry to obtain particles, and
a step of calcining the particles to obtain a catalyst, wherein
in a solid-state ²⁹Si-NMR spectrum of the first wet silica, a ratio of the total area of Q2 signal and Q3 signal to the total area of Q2 signal, Q3 signal, and Q4 signal is 12 to 35%.

The temperature for spray drying in the methods according to the fourth and the fifth embodiments is not particularly limited, but the inlet temperature of the spray drying apparatus is preferably 150 to 300° C., and the outlet temperature thereof is preferably 100 to 160° C.

The temperature for calcining in the methods according to the fourth and the fifth embodiments is not particularly limited, but it is preferably 500 to 800° C. It is preferable to carry out calcining under an inert gas (e.g., nitrogen).

### <Method for Manufacturing Unsaturated Nitrile>

The method for manufacturing an unsaturated nitrile according to the sixth embodiment of the present invention includes a step of obtaining an unsaturated nitrile by a vapor phase catalytic ammoxidation reaction of a hydrocarbon in the presence of the catalyst described in the aforementioned column <Catalyst>. The step is specifically a step of obtaining an unsaturated nitrile by allowing a hydrocarbon, ammonia, and molecular oxygen to react with each other in a vapor phase.

Examples of the hydrocarbons for use in the method according to the sixth embodiment include propane and isobutane.

The unsaturated nitrile manufactured by the method according to the sixth embodiment is acrylonitrile when propane is used as a starting material, and is methacrylonitrile when isobutane is used as a starting material.

A mole ratio between the hydrocarbon, ammonia, and the molecular oxygen is preferably 1:0.8 to 2.5:7 to 12.

The reaction temperature is not particularly limited, but it is preferably 350 to 550° C.

The reaction pressure is not particularly limited, but it is preferably 30 to 50 kPa.

### <Method for Manufacturing Alkene>

The method for manufacturing an alkene according to the seventh embodiment of the present invention includes a step of obtaining an alkene by a vapor phase catalytic oxidation reaction of an alkane in the presence of the catalyst described in the aforementioned column <Catalyst>. The step is specifically a step of obtaining an alkene by allowing an alkane and molecular oxygen to react with each other in a vapor phase.

In addition to an alkene, an aldehyde and/or a carboxylic acid may be obtained by the vapor phase catalytic oxidation reaction of an alkane.

Examples of the alkane for use in the method according to the seventh embodiment include ethane and propane.

The alkene manufactured by the method according to the seventh embodiment is ethylene when ethane is used as a starting material, and is propylene when propane is used as a starting material.

The aldehyde manufactured by the method according to the seventh embodiment is acetaldehyde when ethane is used as a starting material, and is propionaldehyde and acrolein when propane is used as a starting material.

The carboxylic acid manufactured by the method according to the seventh embodiment is acetic acid when ethane is used as a starting material, and is propionic acid and acrylic acid when propane is used as a starting material.

A mole ratio between the alkane and the molecular oxygen is preferably 1:0.2 to 2.0.

The reaction temperature is not particularly limited, but it is preferably 350 to 550° C.

The reaction pressure is not particularly limited, but it is preferably 1 to 50 kPa.

### EXAMPLES

Hereinafter, the present invention will be described in more detail using Examples and Comparative Examples, but the technical scope of the present invention is not limited to this.

“Crystal lattice constant of P1 crystal in the C-axis direction”, “crystal lattice constant of P2 crystal in the C-axis direction”, and “amount of P2 crystal” in these Examples were obtained by Rietveld analysis using measurement data obtained from X-ray diffraction measurement. The X-ray diffraction measurement method and the Rietveld analysis method are as follows.

### Measurement Method

### [X-Ray Diffraction Measurement]

### (Preparation of Sample)

About 0.5 g of a catalyst was put into an agate mortar, and manually crushed for about 1 minute using an agate pestle to obtain a catalyst powder. The resulting catalyst powder was placed in a depression (circular shape having a diameter of 25 mm, depth 1 mm) present on a surface of a sample stand for the XRD measurement, and rubbed through using a flat-plate shaped stainless steel spatula to make the surface flat.

### (Measurement Conditions)

An X-ray diffraction diagram was obtained under the following conditions using D8 Advance manufactured by Bruker AXS, Inc. Under these X-ray diffraction conditions, an X-ray diffraction pattern in the range of 2θ=5° or more and 85° or less was obtained.
X-ray source: CuKα
Detector: LYNXEYE XE (1D mode)
Tube voltage: 40 kV
Tube current: 40 mA
DS (divergence slit): 0.3°
Soller slit (incidence, light-receiving side): 2.5°
Expected width of detector (PSD opening width): 2.9°
Air scatter screen: used
Measurement mode: Two Theta/Theta
Mode: PSD high speed scanning
Time: 0.5 (s)
2θ/start: 5.0°
2θ/stop: 80.0°
Step width: 0.020°

### [Rietveld Analysis]

The Rietveld analysis is a method that is well known as an estimation method for a crystal structure. It is a method to estimate a crystal structure by defining, on the XRD data obtained by measurement of a certain crystal by an X-ray diffractometer (XRD), information of the measurement apparatus (optical system) and a crystal structure existing in the sample, and by adjusting parameters such as lattice constant and proportions of crystal phases so that the measurement data and the calculation pattern may match each other. By carrying out Rietveld analysis, crystal structure data of the P2 crystal and the P1 crystal can be obtained.

As analysis software, TOPAS (DIFFRAC. TOPAS Version 6) from Bruker AXS, Inc. was used. Regarding the P1 crystal, the structure published on Bulletin de La Societe Chimique de France, 1971, 3459-3463 (“EntryWithCollCode26303” in the database of ICSD) was taken as an initial structure, regarding the P2 crystal, the structure published on Applied Catalysis A: General, 2007, vol 318, 20, 137-142 (“EntryWithCollCode157165” in the database of ICSD) was taken as an initial structure, and Rietveld analysis was carried out. Specifically, Rietveld analysis was carried out according to the following procedure.

### <Initial Settings>

Regarding the optical system and apparatus information, such as “Emission Profile (wavelength)” and “Instrument (apparatus constant)”, conditions based on the measurement conditions were set, and the background and the sample surface height were made variable.

### <Input of Sample Information>

Regarding each of the P1 structure and the P2 structure, the initial structure and the conditions for refinement were specified as follows. “Refine” means a variable parameter for the applicable item, and means that refinement is performed so as to match the measurement data. “Scale” means a proportion (mass %) of the crystal in the total, and by refining this, a proportion of the applicable crystal existing in the sample can be determined. By making Stephens models effective, Rietveld analysis can be carried out taking crystal anisotropy into consideration. By making Strain G effective, Rietveld analysis can be carried out taking crystal strain into consideration.

P1

| | |
|---|---|
| Initial structure | Bulletin de la Societe Chimique de France, |
| | 1971, 3459-3463 |
| | ICSD Database [EntryWithCollCode26303] |
| Space group | P-62m(Hexagonal) |
| “Crystal lattice constant | Refine |
| in a-axis direction, | |
| Crystal lattice constant in | |
| c-axis direction” | |
| “scale” | Refine |
| Stephens models | Effective |
| (Stephens_hexagonal) | |
| Strain G | Refine |

P2

| | |
|---|---|
| Initial structure | Applied Catalysis A: General, 2007, vol 318, |
| | 20, 137-142 |
| | ICSD Database [EntryWithCollCode157165] |
| Space group | Pba2(Orthorhombic) |
| “Crystal lattice constant in | Refine |
| a-axis direction, Crystal | |
| lattice constant in b-axis | |
| direction, Crystal lattice | |
| constant in c-axis direction | |
| “scale” | Refine |
| Stephens models | Effective |
| (Stephens_orthorhombic) | |
| Strain G | Refine |

Regarding the structure published on the above database, which was taken as the initial structure, the type, the valence, and the occupancy rate of an element in each site in the structure information were partially modified and used in order to further improve the accuracy of the Rietveld analysis. The initial conditions after the modification are set forth below.

P1

| | Elemental | Coordinate | Coordinate | Coordinate | Occupancy | |
|---|---|---|---|---|---|---|
| Site | species | x | y | z | rate | BEQ |
| Bi1 | Sb | 0.00000 | 0.00000 | 0.50000 | 1 | 0.8 |
| O1 | O | 0.00000 | 0.00000 | 0.00000 | 1 | 1 |
| Ta1 | Mo | 0.49000 | 0.00000 | 0.50000 | 1 | 0.8 |
| O2 | O | 0.50000 | 0.00000 | 0.00000 | 1 | 1 |
| O3 | O | 0.40000 | 0.21000 | 0.50000 | 1 | 1 |

P2

| | Elemental | | | | Occupancy | |
|---|---|---|---|---|---|---|
| Site | species | Coordinate x | Coordinate y | Coordinate z | rate | BEQ |
| Mo1 | Mo | 0.00000 | 0.00000 | 0.50000 | 0.464 | 2.58 |
| V1 | V | 0.00000 | 0.00000 | 0.50000 | 0.536 | 2.58 |
| Mo2 | Mo | 0.00000 | 0.50000 | 0.66100 | 0.63 | 2.58 |
| V2 | V | 0.00000 | 0.50000 | 0.66100 | 0.37 | 2.58 |
| Mo3 | Mo | 0.11970 | 0.22690 | 0.50050 | 0.46 | 2.58 |
| V3 | V | 0.11970 | 0.22690 | 0.50050 | 0.54 | 2.58 |
| Mo4 | Mo | 0.17800 | 0.48170 | 0.53820 | 0.88 | 2.58 |
| V5 | V | 0.17800 | 0.48170 | 0.53820 | 0.12 | 2.58 |
| Mo5 | Mo | 0.21240 | 0.34510 | 0.66210 | 0.8 | 2.58 |
| V7 | V | 0.21240 | 0.34510 | 0.66210 | 0.2 | 2.58 |
| Mo6 | Mo | 0.28290 | 0.20770 | 0.62030 | 1 | 2.58 |
| Mo7 | Mo | 0.38130 | 0.10280 | 0.49020 | 0.62 | 2.58 |
| V9 | V | 0.38130 | 0.10280 | 0.49020 | 0.38 | 2.58 |
| Mo8 | Mo | 0.45870 | 0.22420 | 0.66400 | 1 | 2.58 |
| Nb1 | Nb | 0.3623 | 0.3189 | 0.52130 | 1 | 1.84 |
| Mo9 | Mo | 0.0007 | 0.1328 | 0.625 | 1 | 2.58 |
| Mo10 | Mo | 0.342 | 0.444 | 0.583 | 1 | 2.58 |
| Te1 | Sb | 0.5437 | 0.1037 | 0.5423 | 0.689 | 5.21 |
| O1 | O | 0 | 0 | 0.06 | 1 | 0 |
| O2 | O | 0 | 0.5 | 0.069 | 1 | 0 |
| O3 | O | 0.1187 | 0.2284 | 0.074 | 1 | 0 |
| O4 | O | 0.1812 | 0.4772 | 0.092 | 1 | 0 |
| O5 | O | 0.2155 | 0.3397 | 0.077 | 1 | 0 |
| O6 | O | 0.2824 | 0.2175 | 0.131 | 1 | 0 |
| O7 | O | 0.3893 | 0.1048 | 0.092 | 1 | 0 |
| O8 | O | 0.4507 | 0.2283 | 0.065 | 1 | 0 |
| O9 | O | 0.3504 | 0.3184 | 0.055 | 1 | 0 |
| O10 | O | 0.0073 | 0.1416 | 0.098 | 1 | 0 |
| O11 | O | 0.3452 | 0.4395 | 0.109 | 1 | 0 |
| O12 | O | 0.5413 | 0.1186 | 0.034 | 0.689 | 0 |
| O13 | O | 0.513 | 0.4276 | 0.556 | 1 | 0 |
| O14 | O | 0.5732 | 0.3339 | 0.591 | 1 | 0 |
| O15 | O | 0.0387 | 0.2687 | 0.625 | 1 | 0 |
| O16 | O | 0.5793 | 0.0314 | 0.573 | 1 | 0 |
| O17 | O | 0.6962 | 0.297 | 0.592 | 1 | 0 |
| O18 | O | 0.7792 | 0.2122 | 0.576 | 1 | 0 |
| O19 | O | 0.6655 | 0.0956 | 0.554 | 1 | 0 |
| O20 | O | 0.9601 | 0.429 | 0.577 | 1 | 0 |
| O21 | O | 0.8116 | 0.3561 | 0.535 | 1 | 0 |
| O22 | O | 0.7965 | 0.125 | 0.579 | 1 | 0 |
| O23 | O | 0.7655 | 0.0254 | 0.585 | 1 | 0 |
| O24 | O | 0.8664 | 0.2553 | 0.579 | 1 | 0 |
| O25 | O | 0.9045 | 0.118 | 0.581 | 1 | 0 |
| O26 | O | 0.9066 | 0.0132 | 0.51 | 1 | 0 |
| O19 | O | 0.6655 | 0.0956 | 0.554 | 1 | 0 |
| O20 | O | 0.9601 | 0.429 | 0.577 | 1 | 0 |
| O21 | O | 0.8116 | 0.3561 | 0.535 | 1 | 0 |
| O22 | O | 0.7965 | 0.125 | 0.579 | 1 | 0 |
| O23 | O | 0.7655 | 0.0254 | 0.585 | 1 | 0 |
| O24 | O | 0.8664 | 0.2553 | 0.579 | 1 | 0 |
| O25 | O | 0.9045 | 0.118 | 0.581 | 1 | 0 |
| O26 | O | 0.9066 | 0.0132 | 0.51 | 1 | 0 |
| O27 | O | 0.8372 | 0.45360 | 0.64900 | 1 | 0 |
| O28 | O | 0.94019 | 0.34190 | 0.58400 | 1 | 0 |
| O29 | O | 0.95170 | 0.19950 | 0.56300 | 1 | 0 |
| O30 | O | 0.15320 | 0.30400 | 0.60500 | 1 | 0 |

After the settings were completed as above, fitting of the calculation pattern and the measurement data to each other was carried out. The fitting means that each parameter set, such as lattice constant or a proportion of a crystal phase, is refined so that the calculation pattern and the measurement data may match. “Crystal lattice constant of P1 crystal in the C-axis direction” and “crystal lattice constant of P2 crystal in the C-axis direction” are obtained by refining the crystal lattice constants of the P1 and the P2 crystal structures in the C-axis direction described in Tables 1 and 2. “Amount of P2 crystal” is obtained by refining scale of each of the P1 and the P2 crystal structures described in Tables 1 and 2.

Subsequently, in order to further improve the analysis accuracy, the refinement conditions for thermal vibration parameter (BEQ) of each site, x, y and z coordinates of each site, and metal occupancy rate of each site, for each of the P1 structure and the P2 structure, were set as below.

Regarding the conditions described hereinafter, fitting of the calculation pattern and the measurement data is desirably carried out every time settings for each item are changed. Dut to this, the Rietveld analysis can be carried out accurately.

“Mo3 site” and “V3 site”, “Mo4 site” and “V5 site”, “Mo5 site” and “V7 site”, and “Mo7 site” and “V9 site” in the P2 structure are located at the same positions as each other on the P2 structure, and mean sites that differ in only the elemental species, so that the respective x, y, and z coordinates are specified to be the same (e.g., regarding “Mo3 site” and “V3 site”, their respective coordinates were set to the same variables of x1, y1, and z1). Moreover, regarding them, the variables were set so that the total of the occupancy rates might become 1. (e.g., Regarding “Mo3 site” and “V3 site”, their respective occupancy rates were set to variables of n1 and 1-n1).

In addition, fix means a fixed value for the applicable item, and means that refinement is not carried out. In the case of a site where if refinement is carried out to vary the position, the space group collapses and the Rietveld analysis is not carried out adequately, the analysis was carried out using fixed values as the coordinates.

Furthermore, fitting was repeated until the index “R_wp” indicating fitting accuracy became 10 or less in the fitting result, and thereby the analysis accuracy was enhanced.

P1

| | Elemental | Coordinate | Coordinate | Coordinate | Occupancy | |
|---|---|---|---|---|---|---|
| Site | species | x | y | z | rate | BEQ |
| Bi1 | Sb | fix | fix | fix | 1 | Refine |
| Ta1 | Mo | Refine | Refine | Refine | 1 | Refine |

P2

| | Elemental | Coordinate | Coordinate | Coordinate | Occupancy | |
|---|---|---|---|---|---|---|
| Site | species | x | y | z | rate | BEQ |
| Mo1 | Mo | fix | fix | fix | n1(Refine) | |
| V1 | V | fix | fix | fix | 1-n1(Refine) | |
| Mo2 | Mo | fix | fix | fix | n2(Refine) | |
| V2 | V | fix | fix | fix | 1-n2(Refine) | |
| Mo3 | Mo | x1(Refine) | y1(Refine) | z1(Refine) | n3(Refine) | |
| V3 | V | x1(Refine) | y1(Refine) | z1(Refine) | 1-n3(Refine) | |
| Mo4 | Mo | x2(Refine) | y2(Refine) | z2(Refine) | n4(Refine) | |
| V5 | V | x2(Refine) | y2(Refine) | z2(Refine) | 1-n4(Refine) | |
| Mo5 | Mo | x3(Refine) | y3(Refine) | z3(Refine) | n5(Refine) | |
| V7 | V | x3(Refine) | y3(Refine) | z3(Refine) | 1-n5(Refine) | |
| Mo6 | Mo | Refine | Refine | Refine | 1 | |
| Mo7 | Mo | x4(Refine) | y4(Refine) | z4(Refine) | n6(Refine) | |
| V9 | V | x4(Refine) | y4(Refine) | z4(Refine) | 1-n6(Refine) | |
| Mo8 | Mo | Refine | Refine | Refine | 1 | |
| Nb1 | Nb | Refine | Refine | Refine | 1 | |
| Mo9 | Mo | Refine | Refine | Refine | 1 | |
| Mo10 | Mo | Refine | Refine | Refine | 1 | |
| Te1 | Sb | Refine | Refine | Refine | 1 | |

By carrying out the Rietveld analysis through the method described above, such an XRD calculation pattern as fits well to the XRD measurement data obtained from the experiments can be obtained. The XRD calculation pattern is determined by assuming a certain P1·P2 crystal structure, and therefore, it can be thought that the “crystal lattice constant of P1 crystal in the C-axis direction”, the “crystal lattice constant of P2 crystal in the C-axis direction”, and the “amount of P2 crystal” in the thus assumed P1·P2 crystal indicate the P1·P2 crystal actually existing in the sample measured.

### [Catalyst Composition]

### (X-Ray Fluorescence (XRF) Measurement)

Determination of catalyst composition was made by the fundamental parameter (FP) method using X-ray fluorescence analysis (product name “RINT 1000” manufactured by Rigaku Corporation, Cr tubular bulb, tube voltage 50 kV, tube current 50 mA).

Specifically, the resulting catalyst was crushed and mixed for 2 hours using an automatic uniaxial agate mortar (manufactured by NITTO KAGAKU CO., Ltd.), and subjected to pressure molding with a uniaxial press using a vinyl chloride ring (manufactured by Rigaku Corporation). Using wavelength dispersion type X-ray fluorescence analysis (product name “RINT 1000” manufactured by Rigaku Corporation, Cr tubular bulb, tube voltage 50 kV, tube current 50 mA), the resulting pellets were measured by the fundamental parameter (FP) method for determining a content from the sensitivity library having been registered into software in advance, through semiquantitative analysis.

### [Q2 to Q4 Signals]

### (²⁹Si Solid-State NMR Measurement)

For the measurement, Avance 500 manufactured by Bruker BioSpin Group was used. The ²⁹Si resonance frequency was 99.35 MHz.

A 7 mm-diameter NMR sample tube was charged with a sample, and the sample was subjected to measurement. Under the conditions of a pulse width of 45°, a waiting time of 100 seconds, integration frequencies of 200, and MAS (Magic Angle Spinning) of 5000 Hz, DD (Dipolar Decoupling) method was used as the measurement method, and a pulse sequence of hpdec was used. An external standard of the chemical shift of silicone rubber was set to −22.43 ppm. LB (line broadening) of the exponential function during Fourier transform was set to 100 Hz.

Phase correction and baseline correction of the resulting spectrum were carried out, and then, using waveform processing software (Pasokon ni yoru FT-NMR no Deta Shori, in Japanese (Data Processing of FT-NMR by Computer), written by Hiroshi Nakamura, SANKYO SHUPPAN Co., Ltd.), peak deconvolution of Q structure signals was carried out.

The shift positions of Q4, Q3, and Q2 signals were set to −111.6 ppm, −101.6 ppm, and −92.4 ppm, respectively, the half widths were set to 420 Hz, 330 Hz, and 290 Hz, respectively, as the initial values, and the strength was determined according to the signal shape, and thereafter, peak deconvolution was carried out by the least squares method using the shift position, the half width, and the strength as variable parameters. As the function, a mixed function in which the Lorenz function/Gaussian function ratio was fixed to 0.5 was used.

### <Preparation of Catalyst>

### Example 1

### (Slurry Preparation Step 1: Preparation of Aqueous Mixed Liquid (A1))

To 1492 g of water, 279.2 g of ammonium heptamolybdate [(NH₄)₆MO₇O₂₄·4H₂O], 35.2 g of ammonium metavanadate [NH₄VO₃], 59.9 g of antimony trioxide [Sb₂O₃], and 4.9 g of cerium nitrate [Ce(NO₃)₃·6H₂O] were added, and they were heated at 98° C. for 2 hours with stirring to prepare an aqueous mixed liquid (A1).

### (Slurry Preparation Step 2: Preparation of Niobium Starting Material Liquid (B1))

Into a mixing vessel, 57.9 kg of water was added, and thereafter, the water was heated up to 45° C. Next, with stirring the water, 72.2 kg of oxalic acid dihydrate [H₂C₂O₄·2H₂O] was introduced, subsequently 19.9 kg of niobic acid containing 76.0 mass % of Nb₂O₅ was introduced, and both were mixed in the water. This liquid was stirred under heating at 90° C. for 2 hours to obtain an aqueous mixed liquid. This aqueous mixed liquid was allowed to stand, and ice-cooled, and then, a solid was filtered out by suction filtration to obtain a homogeneous niobium starting material liquid (B1). An oxalic acid/niobium mole ratio in this niobium starting material liquid proved to be 2.25 by the following analysis.

The oxalic acid/niobium mole ratio in the niobium starting material liquid (B1) was calculated in the following manner.

In a crucible, 10 g of the niobium staring material liquid (B1) was precisely weighed, dried at 120° C. for 2 hours, and thereafter heat-treated at 600° C. for 2 hours to obtain a solid, then from the weight of Nb₂O₅ of the solid, a Nb concentration of the aqueous mixed liquid was calculated, and as a result, the Nb concentration was 1.072 mol/kg.

Furthermore, in a 300 mL glass beaker, 3 g of the niobium starting material liquid (B1) was precisely weighed, 20 mL of hot water at about 80° C. was added, and subsequently, 10 mL of 1:1 sulfuric acid was added. While the liquid temperature of the mixed liquid obtained as above was kept at 70° C. in a water bath, titration was carried out using ¼ N KMnO₄ with stirring the mixed liquid. The point at which a faint pale pink color due to the KMnO₄ lasted for about 30 seconds or more was regarded as an endpoint. An oxalic acid concentration was calculated from the titer in accordance with the following formula, and as a result, the oxalic acid concentration was 2.41 mol/kg.

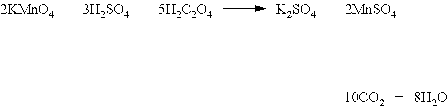

### (Slurry Preparation Step 3: Preparation of Precursor Slurry (C1))

After the aqueous mixed liquid (A1) was cooled to 70° C., thereto was added 696.8 g of a silica sol (first wet silica) containing 34.1 mass % of SiO₂ and having an average particle diameter of 12 nm, and when the liquid temperature became 55° C., 158.5 g of a hydrogen peroxide solution containing 30 mass % of H₂O₂ was added to obtain an aqueous mixed liquid (A1′). Immediately thereafter, to the aqueous mixed liquid (A1′), 200.7 g of the niobium starting material liquid (B1), 29.3 g of an ammonium metatungstate (purity 50%), and a dispersion in which 176 g of powder silica (fumed silica) was dispersed in 1584 g of water were added in order, then 40.3 g of 25% ammonia water was added, and they were stirred and aged at 65° C. for 2 hours to obtain a mixed liquid having pH of 4.9. Thereto was added 77.4 g of a silica sol (second wet silica) containing 34.1 mass % of SiO₂, and they were stirred and aged for 40 minutes to obtain a precursor slurry (C1).

### (Spray Drying Step: Preparation of Dry Particles (D1))

The precursor slurry (C1) was fed to a centrifugal spray dryer and dried to obtain microspherical dry particles (D1). The drying heat source was air. The inlet temperature of the dryer was 210° C., and the outlet temperature thereof was 120° C. The resulting dry particles (D1) were classified using a sieve having an opening of 32 μm to obtain dry particles (D1) that were classified products.

### (Calcining Step: Preparation of Catalyst (E1))

A Pyrex (registered trademark) calcining tube having a diameter of 3 inches was charged with 100 g of the dry particles (D1), and while the tube was rotated, the dry particles were calcined at 685° C. for 2 hours under a nitrogen gas flow at 0.2 NL/min to obtain a catalyst (E1).

### (Removal Step)

Into a vertical tube (inner diameter 41.6 mm, length 70 cm) provided with a perforated disk having three holes with a diameter of 1/64 inch on the bottom and provided with a paper filter at the top, 50 g of the catalyst (D1) was introduced. Subsequently, air was allowed to flow at room temperature from below to above the vertical tube through each hole to promote contact of the catalysts with each other. At this time, the airflow length in the airflow direction was 56 mm, and the average linear velocity of the airflow was 332 m/s. In the catalyst (E1) obtained after 24 hours, no protrusion was present.

Regarding the catalyst (E1) obtained, the composition of the catalyst obtained at this time was Mo₁V_{0.195}Sb_{0.261} Nb_{0.137}W_{0.041}Ce_{0.006}Oₙ/55.7 mass %-SiO₂.

### Examples 2 to 4

A catalyst was prepared in the same manner as in Example 1, except that pH of the slurry to which the second wet silica was to be added, and the time from mixing of the second wet silica to spray drying were changed as shown in Table 1 below.

### Comparative Example 1

A catalyst was prepared in the same manner as in Example 1, except that the second wet silica was not mixed.

### Example 5

A catalyst was prepared in the same manner as in Example 1, except that 25% ammonia water was added to adjust pH to 12.5 before the first wet silica was added.

### Example 6

A catalyst was prepared in the same manner as in Example 1, except that 25% ammonia water was added to adjust pH to 12.8 before the first wet silica was added, and the second wet silica was not added.

### Example 7

A catalyst was prepared in the same manner as in Example 1, except that 25% ammonia water was added to adjust pH to 13.0 before the first wet silica was added, and the second wet silica was not added.

### Example 8

A catalyst was prepared in the same manner as in Example 1, except that 25% ammonia water was added to adjust pH to 13.2 before the first wet silica was added, and the second wet silica was not added.

### Example 9

A catalyst was prepared in the same manner as in Example 1, except that 25% ammonia water was added to adjust pH to 13.4 before the first wet silica was added, and the second wet silica was not added.

### Comparative Example 2

A catalyst was prepared in the same manner as in Example 1, except that 25% ammonia water was added to adjust pH to 12.3 before the first wet silica was added, and the second wet silica was not added.

### Comparative Example 3

A catalyst was prepared in the same manner as in Example 1, except that the second wet silica was not added.

### Comparative Example 4

A catalyst was prepared in the same manner as in Example 1, except that large silica having a particle diameter of 20 nm was used as the first wet silica, and the second wet silica was not added.

### Comparative Example 5

A catalyst was prepared in the same manner as in Example 1, except that large silica having a particle diameter of 25 nm was used as the first wet silica, and the second wet silica was not added.

### Comparative Example 6

A catalyst was prepared in the same manner as in Example 1, except that 25% ammonia water was added to adjust pH to 13.9 before the first wet silica was added, and the second wet silica was not added.

### <Vapor Phase Catalytic Ammoxidation Reaction>

Acrylonitrile was manufactured from propane by a vapor phase catalytic ammoxidation reaction using the catalyst obtained by each of Examples and Comparative Examples. Specifically, a Vycor glass fluidized bed type reaction tube having an inner diameter of 25 mm was charged with 40 g of the catalyst, and a mixed gas of propane: ammonia: oxygen: helium=1:1.1:2.9:11.6 mole ratio was fed at a reaction temperature of 445° C. and at a reaction pressure of 40 kPa for a contact time of 3.0 (sec·g/cm³).

The yield of acrylonitrile was determined in the following manner.

A gas of acrylonitrile having an already known concentration was analyzed by gas chromatography (GC: product name “GC2014” manufactured by Shimadzu Corporation) to obtain a calibration curve, thereafter a gas generated by the ammoxidation reaction was injected into GC in a fixed amount, and the number of moles of acrylonitrile was measured. From the thus measured number of moles of acrylonitrile, yield of acrylonitrile was determined in accordance with the following equation.

$$Yield of acrylonitrile ( \% ) = ( number of moles of acrylonitrile generated ) \text{} / ( number of moles of propane fed ) \times 100$$

Regarding this catalyst, reaction was continuously carried out, and yields of acrylonitrile (AN) measured 10 days after the start of the reaction are set forth in Table 1 and Table 2.

### <Vapor Phase Catalytic Oxidation Reaction>

Ethylene was manufactured from ethane by a vapor phase catalytic oxidation reaction using the catalyst obtained by each of Examples and Comparative Examples. Specifically, a fixed-bed reactor (10 mm diameter) was charged with 2.0 g of the oxidation reaction catalyst, and a mixed gas (20.0 vol % ethane, 20.0 vol % oxygen, 60.0 vol % helium) was introduced at a predetermined temperature (445° C.) and a predetermined pressure (6 kPa), with the flow rate adjusted so that the ethane conversion rate was 85 to 86%. The yield of ethylene was calculated as follows.

A gas of ethylene having an already known concentration was analyzed by gas chromatography (GC: product name “GC2014” manufactured by Shimadzu Corporation) to obtain a calibration curve, thereafter a gas generated by the oxidation reaction was injected into GC in a fixed amount, and the number of moles of ethylene was measured. From the thus measured number of moles of ethylene, yield of ethylene was determined in accordance with the following equation.

$$Yield of ethylene ( \% ) = ( number of moles of ethylene generated ) \text{} / ( number of moles of ethylene fed ) \times 100$$

The gas generated 2 hours after the start of the oxidation reaction was analyzed by gas chromatography. The yield of ethylene is shown in Table 3 and Table 4.

TABLE 1

| | | Time from | | | | P2-C-axis | | | |
|---|---|---|---|---|---|---|---|---|---|
| | | mixing of | pH of slurry | | | lattice | | | |
| | | second silica | immediately | | | constant/ | | Amount | |
| | | to spray | before mixing | P1-C-axis | P2-C-axis | P1-C-axis | | of P2 | |
| | Second | drying | of second | lattice | lattice | lattice | | crystal | AN |
| | silica | (min) | silica | constant | constant | constant | R_wp | (mass %) | yield |
| Example 1 | present | 40 | 4.9 | 3.9988 | 4.0276 | 1.0072 | 7.93 | 44.1 | 56.7 |
| Example 2 | present | 35 | 5.3 | 4.0002 | 4.0270 | 1.0067 | 7.7 | 47.2 | 56.8 |
| Example 3 | present | 20 | 5.6 | 4.0025 | 4.0261 | 1.0059 | 7.77 | 61.3 | 57 |
| Example 4 | present | 15 | 6.2 | 4.0058 | 4.0250 | 1.0048 | 7.32 | 75.8 | 57.1 |
| Comparative | absent | — | — | 3.9820 | 4.0342 | 1.0131 | 7.34 | 30.2 | 55 |
| Example 1 | | | | | | | | | |

TABLE 2

| | | | | | P2-C-axis | | | |
|---|---|---|---|---|---|---|---|---|
| | | | | | lattice | | | |
| | | | | | constant/ | | Amount | |
| | | First silica | P1-C-axis | P2-C-axis | P1-C-axis | | of P2 | |
| | Second | (Q2 + Q3)/ | lattice | lattice | lattice | | crystal | AN |
| | silica | (Q1 + Q2 + Q3) | constant | constant | constant | R_wp | (mass %) | yield |
| Example 5 | absent | 13 | 3.9965 | 4.0297 | 1.0083 | 7.32 | 40.5 | 56.3 |
| Example 6 | absent | 15 | 3.9985 | 4.0277 | 1.0073 | 7.49 | 44 | 56.7 |
| Example 7 | absent | 21 | 4.0019 | 4.0259 | 1.0060 | 7.65 | 61.2 | 57 |
| Example 8 | absent | 26 | 4.0051 | 4.0251 | 1.0050 | 7.23 | 75.6 | 57.1 |
| Example 9 | absent | 29 | 4.0061 | 4.0233 | 1.0043 | 7.72 | 79.5 | 57.2 |
| Comparative | absent | 9 | 3.9882 | 4.0329 | 1.0112 | 7.6 | 31.8 | 55.5 |
| Example 2 | | | | | | | | |
| Comparative | absent | 8 | 3.9865 | 4.0355 | 1.0123 | 7.77 | 30.5 | 55.3 |
| Example 3 | | | | | | | | |
| Comparative | absent | 6 | 3.9863 | 4.0381 | 1.0130 | 7.46 | 29 | 55.2 |
| Example 4 | | | | | | | | |
| Comparative | absent | 4 | 3.9852 | 4.0430 | 1.0145 | 7.13 | 22.4 | 55 |
| Example 5 | | | | | | | | |
| Comparative | absent | 45 | 3.9848 | 4.0430 | 1.0146 | 7.11 | 22.5 | 55.1 |
| Example 6 | | | | | | | | |

TABLE 3

| | | Time from | | | | | | | |
|---|---|---|---|---|---|---|---|---|---|
| | | mixing of | | | | P2-C-axis | | | |
| | | second | pH of slurry | | | lattice | | | |
| | | silica | immediately | | | constant/ | | Amount | |
| | | to spray | before mixing | P1-C-axis | P2-C-axis | P1-C-axis | | of P2 | |
| | Second | drying | of second | lattice | lattice | lattice | | crystal | Ethylene |
| | silica | (min) | silica | constant | constant | constant | R_wp | (mass %) | yield |
| Example 1 | present | 40 | 4.9 | 3.9988 | 4.0276 | 1.0072 | 7.93 | 44.1 | 70.8 |
| Example 2 | present | 35 | 5.3 | 4.0002 | 4.0270 | 1.0067 | 7.7 | 47.2 | 71 |
| Example 3 | present | 20 | 5.6 | 4.0025 | 4.0261 | 1.0059 | 7.77 | 61.3 | 71.1 |
| Example 4 | present | 15 | 6.2 | 4.0058 | 4.0250 | 1.0048 | 7.32 | 75.8 | 71.4 |
| Comparative | absent | — | — | 3.9820 | 4.0342 | 1.0131 | 7.34 | 30.2 | 69.8 |
| Example 1 | | | | | | | | | |

TABLE 4

| | | | | | P2-C-axis | | | |
|---|---|---|---|---|---|---|---|---|
| | | | | | lattice | | | |
| | | | | | constant/ | | Amount | |
| | | First silica | P1-C-axis | P2-C-axis | P1-C-axis | | of P2 | |
| | Second | (Q2 + Q3) | lattice | lattice | lattice | | crystal | Ethylene |
| | silica | (Q1 + Q2 + Q3) | constant | constant | constant | R_wp | (mass %) | yield |
| Example 5 | absent | 13 | 3.9965 | 4.0297 | 1.0083 | 7.32 | 40.5 | 70.8 |
| Example 6 | absent | 15 | 3.9985 | 4.0277 | 1.0073 | 7.49 | 44 | 70.9 |
| Example 7 | absent | 21 | 4.0019 | 4.0259 | 1.0060 | 7.65 | 61.2 | 71 |
| Example 8 | absent | 26 | 4.0051 | 4.0251 | 1.0050 | 7.23 | 75.6 | 71.3 |
| Example 9 | absent | 29 | 4.0061 | 4.0233 | 1.0043 | 7.72 | 79.5 | 71.5 |
| Comparative | absent | 9 | 3.9882 | 4.0329 | 1.0112 | 7.6 | 31.8 | 69.9 |
| Example 2 | | | | | | | | |
| Comparative | absent | 8 | 3.9865 | 4.0355 | 1.0123 | 7.77 | 30.5 | 69.8 |
| Example 3 | | | | | | | | |
| Comparative | absent | 6 | 3.9863 | 4.0381 | 1.0130 | 7.46 | 29 | 69.7 |
| Example 4 | | | | | | | | |
| Comparative | absent | 4 | 3.9852 | 4.0430 | 1.0145 | 7.13 | 22.4 | 69.5 |
| Example 5 | | | | | | | | |
| Comparative | absent | 45 | 3.9848 | 4.0430 | 1.0146 | 7.11 | 22.5 | 69.6 |
| Example 6 | | | | | | | | |

1. A catalyst comprising a metal oxide containing molybdenum and vanadium, wherein
the catalyst comprises a P1 crystal and a P2 crystal, and
a ratio of a crystal lattice constant of the P2 crystal in the C-axis direction to a crystal lattice constant of the P1 crystal in the C-axis direction is 1.0030 to 1.0100.

2. The catalyst according to claim 1, wherein the crystal lattice constant of the P2 crystal in the C-axis direction is 4.0200 \acute{Å} to 4.0298 \acute{Å}.

3. The catalyst according to claim 1, wherein the crystal lattice constant of the P1 crystal in the C-axis direction is 3.9900 \acute{Å} to 4.0080 \acute{Å}.

4. The catalyst according to claim 1, wherein the catalyst is for use in a vapor phase catalytic ammoxidation reaction or a vapor phase catalytic oxidation reaction.

5. The catalyst according to claim 1, wherein an amount of the P2 crystal based on the total mass of the P1 crystal and the P2 crystal is 40 mass % or more.

6. The catalyst according to claim 1, wherein the metal oxide is represented by the following formula (1): 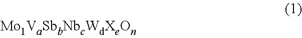
wherein X is at least one selected from the group consisting of Te, Ce, Ti, and Ta,
a is 0.01 or more and 1 or less,
b is 0.01 or more and 1 or less,
c is 0.01 or more and 1 or less,
d is 0 or more and 1 or less,
e is 0 or more and 1 or less, and
n is a value determined by the X and the a to e.

7. A method for manufacturing a catalyst, comprising
a step of preparing a slurry containing molybdenum, vanadium, and a first wet silica,
a step of spray drying the slurry to obtain particles, and
a step of calcining the particles to obtain a catalyst, wherein
at least one of (1) and (2) below is satisfied:
(1) the method further comprises mixing a second wet silica with the slurry when pH of the slurry is 3 to 8; and
(2) in a solid-state ²⁹Si—NMR spectrum of the first wet silica, a ratio of the total area of Q2 signal and Q3 signal to the total area of Q2 signal, Q3 signal, and Q4 signal is 12 to 35%.

8. The method according to claim 7, wherein the first wet silica and the second wet silica are silica sols.

9. The method according to claim 7, wherein the spray drying is performed within 60 minutes after the second wet silica is mixed.

10. A method for manufacturing an unsaturated nitrile, comprising a step of obtaining an unsaturated nitrile by a vapor phase catalytic ammoxidation reaction of a hydrocarbon in the presence of the catalyst according to claim 1.

11. A method for manufacturing an alkene, comprising a step of obtaining an alkene by a vapor phase catalytic oxidation reaction of an alkane in the presence of the catalyst according to claim 1.
